(19) United States
(12) Patent Application Publication
(10) Pub. No.: US 2023/0156206 A1
(43) Pub. Date: May 18, 2023

(54) VIDEO ENCODING SYSTEM AND VIDEO ENCODING METHOD

(71) Applicant: NEC Corporation, Minato-ku, Tokyo (JP)

(72) Inventors: Takayuki ISHIDA, Tokyo (JP); Tatsuji MORIYOSHI, Tokyo (JP); Kenta IIDA, Tokyo (JP)

(73) Assignee: NEC Corporation, Minato-ku, Tokyo (JP)

(21) Appl. No.: 17/802,378

(22) PCT Filed: Feb. 24, 2021
(86) PCT No.: PCT/JP2021/006721

§ 371 Date: Aug. 25, 2022

(30) Foreign Application Priority Data
Mar. 24, 2020 (JP) 2020-052601

(51) Int. Cl. H04N 19/436; H04N 19/146

(52) U.S. Cl. CPC H04N 19/436; H04N 19/146

(57) ABSTRACT

In order to make it possible to perform compression encoding of video more quickly and by an easier method, processing relating to the compression encoding of the video that has a greater speed-increasing effect due to parallel processing is performed by a parallel processing device that can execute the parallel processing more rapidly than a

CPU, processing with a high computational load and processing that requires high-speed processing based on sequential processing are performed by a sequential processing device that can execute the sequential processing more rapidly than the CPU, and processing that involves a higher frequency of alteration of content of an algorithm is performed by the CPU.

### TECHNICAL FIELD

The present invention relates to a video encoding system and a video encoding method.

### BACKGROUND ART

As the definition of a video is increased, a load of video encoding processing is increased.

As a method of achieving the video encoding processing, first, there is a method of using a hardware encoder such as a dedicated large scale integrated circuit (LSI). There are a method of achieving encoding processing using a central processing unit (CPU), a method of achieving encoding processing using a CPU and a field programmable gate array (FPGA), and a method of achieving encoding processing using a CPU and a graphics processing unit (GPU). For example, PTL 1 describes that processing with a heavy load is offloaded to a GPU, and encoding processing is achieved using a CPU and the GPU.

### CITATION LIST

### Patent Literature

[PTL 1] WO 2012/176368 A

### SUMMARY OF INVENTION

### Technical Problem

The method of using a hardware encoder using a dedicated LSI has advantages of easy size reduction and high reliability. However, this method has a very high development cost and a long development period.

The method of achieving all the processing using the CPU has an advantage that development is easy as compared with the method of using a hardware encoder. However, this method is slower in processing speed than the method of using a hardware encoder.

The method of using the CPU and the GPU and the method of using the CPU and the FPGA can speed up compression encoding as compared with the method of achieving all the processing by using the CPU. Development is easier than the method of using a hardware encoder using a dedicated LSI.

However, with the advent of new compression encoding techniques such as versatile video coding (VVC), it is desired to further speed up the compression encoding processing by a simpler method. For example, the processing time of VVC is about ten times longer than that of H.265 (high efficiency video coding (HEVC)). Therefore, it is desirable to further speed up such compression encoding processing by a simpler method (a method with low development cost, a method with short development period, or the like).

An object of the present invention is to provide a video encoding system and a video encoding method that enable compression encoding of a video to be performed at a higher speed by a simpler method.

### Solution to Problem

According to an aspect of the present invention, a video encoding system includes a CPU, a parallel processing device capable of executing parallel processing at a higher speed than the CPU, and a sequential processing device capable of executing sequential processing at a higher speed than the CPU, in which the parallel processing device performs processing having a greater speed-increasing effect by performing the parallel processing among pieces of processing related to compression encoding of a video, the sequential processing device performs processing with a high computational load or processing that requires high-speed processing based on the sequential processing among the pieces of processing related to the compression encoding, and the CPU performs processing that involves a high frequency of alteration of content of an algorithm among the pieces of processing related to the compression encoding.

According to another aspect of the present invention, a video encoding method includes performing, among pieces of processing related to compression encoding of a video, processing having a greater speed-increasing effect by performing parallel processing by a parallel processing device capable of executing the parallel processing at a higher speed than a CPU, performing processing with a high computational load or processing that requires high-speed processing based on sequential processing by a sequential processing device capable of executing the sequential processing at a higher speed than the CPU, and performing processing that involves a high frequency of alteration of content of an algorithm by the CPU.

### Advantageous Effects of Invention

According to the present invention, compression encoding of a video can be performed at a higher speed by a simpler method.

### BRIEF DESCRIPTION OF DRAWINGS

FIG. 1 is a diagram illustrating a configuration example of a video encoding system of a first example embodiment of the present invention.

FIG. 2 is a diagram illustrating an operation example of the video encoding system of the first example embodiment of the present invention.

FIG. 3 is a diagram illustrating a configuration example of a video encoding system of a second example embodiment of the present invention.

FIG. 4 is a diagram illustrating another configuration example of the video encoding system of the second example embodiment of the present invention.

FIG. 5 is a diagram illustrating a hardware configuration example of each example embodiment of the present invention.

### EXAMPLE EMBODIMENT

### First Example Embodiment

The first example embodiment of the present invention is described.

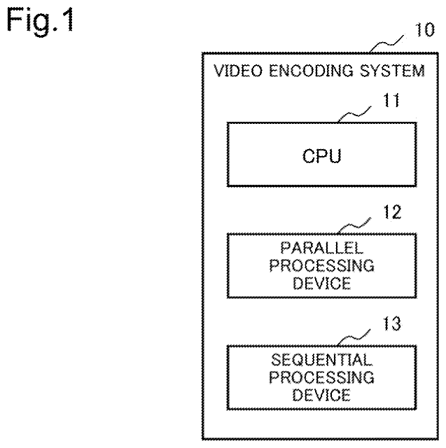

FIG. 1 illustrates a configuration example of a video encoding system 10 of the present example embodiment. The video encoding system 10 of the present example embodiment includes a CPU 11, a parallel processing device 12, and a sequential processing device 13.

It is assumed that the parallel processing device 12 can execute parallel processing at a higher speed than the CPU 11. It is assumed that the sequential processing device 13 can execute sequential processing at a higher speed than the CPU 11.

The parallel processing device 12 performs processing having a greater speed-increasing effect by performing the parallel processing among pieces of processing related to compression encoding of a video. The sequential processing device 13 performs processing with a high computational load or processing that requires high-speed processing based on sequential processing among pieces of processing related to compression encoding. The CPU 11 performs processing that involves a high frequency of alteration of content of an algorithm among pieces of processing related to compression encoding.

By configuring the video encoding system 10 in this manner, in the video encoding system 10, the parallel processing device 12 capable of executing the parallel processing at a higher speed than the CPU 11 performs processing having a greater speed-increasing effect by performing the parallel processing. The sequential processing device 13 capable of executing the sequential processing at a higher speed than the CPU 11 performs the processing with a high computational load or the processing that requires high-speed processing based on the sequential processing. The CPU 11 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

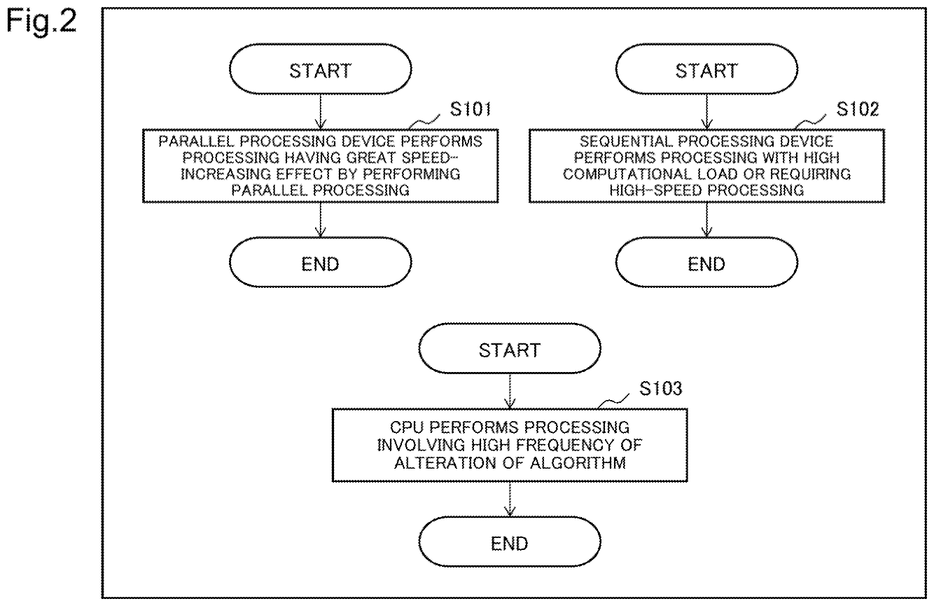

Next, FIG. 2 illustrates an example of an operation of the video encoding system 10 of the present example embodiment.

The parallel processing device 12 performs processing having a greater speed-increasing effect by performing the parallel processing among pieces of processing related to compression encoding of a video (Step S101). The sequential processing device 13 performs processing with a high computational load or processing that requires high-speed processing based on sequential processing among pieces of processing related to compression encoding (Step S102). The CPU 11 performs processing that involves a high frequency of alteration of content of an algorithm among pieces of processing related to compression encoding (Step S103).

The video encoding system 10 operates as described above in such a way that the parallel processing device 12 capable of executing the parallel processing at a higher speed than the CPU 11 performs processing having a greater speed-increasing effect by performing the parallel processing. The sequential processing device 13 capable of executing the sequential processing at a higher speed than the CPU 11 performs the processing with a high computational load or the processing that requires high-speed processing based on the sequential processing. The CPU 11 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

As described above, in the first example embodiment of the present invention, in the video encoding system 10, the parallel processing device 12 capable of executing the parallel processing at a higher speed than the CPU 11 performs processing having a greater speed-increasing effect by performing the parallel processing. The sequential processing device 13 capable of executing the sequential processing at a higher speed than the CPU 11 performs the processing with a high computational load or the processing that requires high-speed processing based on the sequential processing. The CPU 11 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

### Second Example Embodiment

Next, a video encoding system 20 of the second example embodiment of the present invention is described. In the present example embodiment, an example of a case where the system of compression encoding of a video is VVC is described.

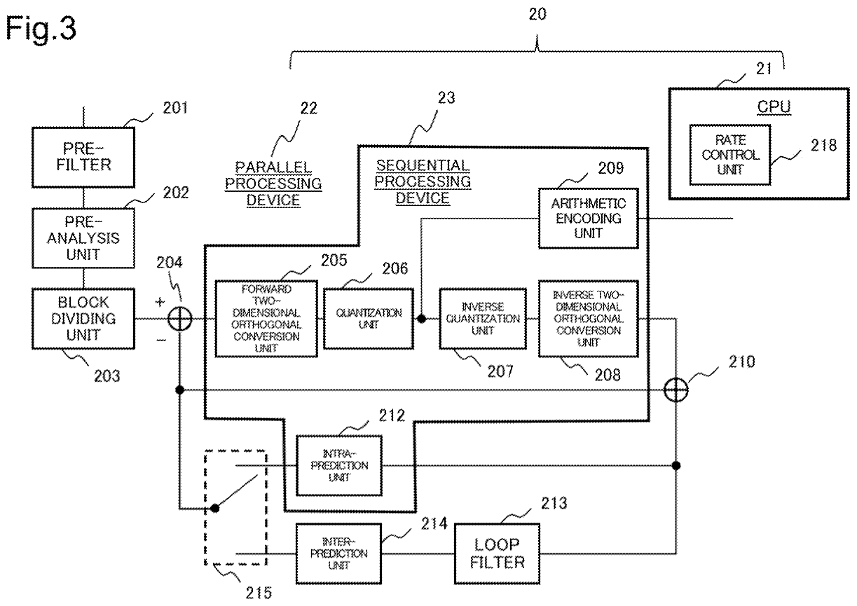

First, FIG. 3 illustrates a configuration example of the video encoding system 20 of the present example embodiment. The video encoding system 20 of the present example embodiment includes a CPU 21, a parallel processing device 22, and a sequential processing device 23.

Although the CPU 21 can easily alter a processing algorithm, the processing speed is not faster than that of the FPGA. In the case of processing capable of parallel processing, the processing time of the CPU 21 is longer than that of the GPU. Therefore, although the necessity of high-speed processing is not so high, the CPU 21 is suitable for executing processing that involves a high frequency of alteration of content of an algorithm.

The parallel processing device 22 is a device capable of executing parallel processing at a higher speed than the CPU 21, and is equipped with, for example, a GPU. The GPU can execute the parallel processing at high speed. Therefore, the GPU is suitable for executing processing having a greater speed-increasing effect by the parallel processing.

The sequential processing device 23 is a device capable of executing the sequential processing at a higher speed than the CPU 21, and is equipped with, for example, an FPGA. The FPGA can execute the sequential processing at high speed. However, the FPGA takes time and effort to develop, and the processing content is restricted by the circuit scale. Therefore, the FPGA is suitable for executing processing with a high computational load or processing that requires high-speed processing based on sequential processing among pieces of processing that involve a low frequency of alteration of content of an algorithm. The FPGA is also suitable for performing processing that is difficult to perform in parallel processing due to a dependency relationship with other processing or the like.

In the video encoding system 20 of the present example embodiment, the parallel processing device 22 performs processing having a greater speed-increasing effect by performing the parallel processing among pieces of processing related to compression encoding of a video. The sequential processing device 23 performs processing with a high computational load or processing that requires high-speed processing based on sequential processing among pieces of processing related to compression encoding. The CPU 21 performs processing that involves a high frequency of alteration of content of an algorithm among pieces of processing related to compression encoding.

Data transfer between the sequential processing device 23 and the parallel processing device 22 may be performed via the CPU 21 or may be performed without the CPU 21.

For example, the parallel processing device 22 includes a pre-filter 201, a pre-analysis unit 202, a loop filter 213, and an inter-prediction unit 214.

For example, the sequential processing device 23 includes a forward two-dimensional orthogonal conversion unit 205, a quantization unit 206, an inverse quantization unit 207, an inverse two-dimensional orthogonal conversion unit 208, an arithmetic encoding unit 209, and an intra-prediction unit 212.

For example, the CPU 21 includes a rate control unit 218.

A block dividing unit 203 is connected to the pre-analysis unit 202 and a subtraction unit 204. The subtraction unit 204 is connected to the block dividing unit 203, the forward two-dimensional orthogonal conversion unit 205, and a switching unit 215. An addition unit 210 is connected to the inverse two-dimensional orthogonal conversion unit 208, the switching unit 215, the intra-prediction unit 212, and the loop filter 213. The switching unit 215 is connected to the intra-prediction unit 212, the inter-prediction unit 214, the addition unit 210, and the subtraction unit 204.

The pre-filter 201 is a filter applied to an input image for the purpose of reducing encoding complexity. The processing performed by the pre-filter 201 is processing having a great speed-increasing effect by the parallel processing. Therefore, the parallel processing device 22 performs the processing of the pre-filter 201.

The pre-analysis unit 202 analyzes an image processed by the pre-filter 201. The analysis result is used for determining a scene change or the like, and is used for determining various encoding parameters by the rate control unit 218. The processing performed by the pre-analysis unit 202 is processing having a great speed-increasing effect by the parallel processing and that involves a low frequency of alteration of content of an algorithm. Therefore, the parallel processing device 22 performs the processing of the pre-analysis unit 202.

The block dividing unit 203 divides the image output from the pre-analysis unit 202 into blocks of encoding processing units. The processing of the block dividing unit 203 may be performed by any of the CPU 21, the parallel processing device 22, and the sequential processing device 23.

The subtraction unit 204 calculates a difference between the image output from the block dividing unit 203 and a prediction image output from the switching unit 215.

The processing of the subtraction unit 204 may be performed by any of the CPU 21, the parallel processing device 22, and the sequential processing device 23.

The forward two-dimensional orthogonal conversion unit 205 performs frequency conversion on the image output from the subtraction unit 204. The quantization unit 206 performs quantization on the output of the forward two-dimensional orthogonal conversion unit 205. The forward two-dimensional orthogonal conversion unit 205 and the quantization unit 206 adjust (increase or reduce) the value of the transmission bit rate by frequency conversion and quantization.

The inverse quantization unit 207 performs inverse quantization on the output of the quantization unit 206. The inverse two-dimensional orthogonal conversion unit 208 performs inverse two-dimensional orthogonal conversion on the output of the inverse quantization unit 207. The inverse quantization and the inverse two-dimensional orthogonal conversion are performed for prediction in the intra-prediction unit 212 and the inter-prediction unit 214.

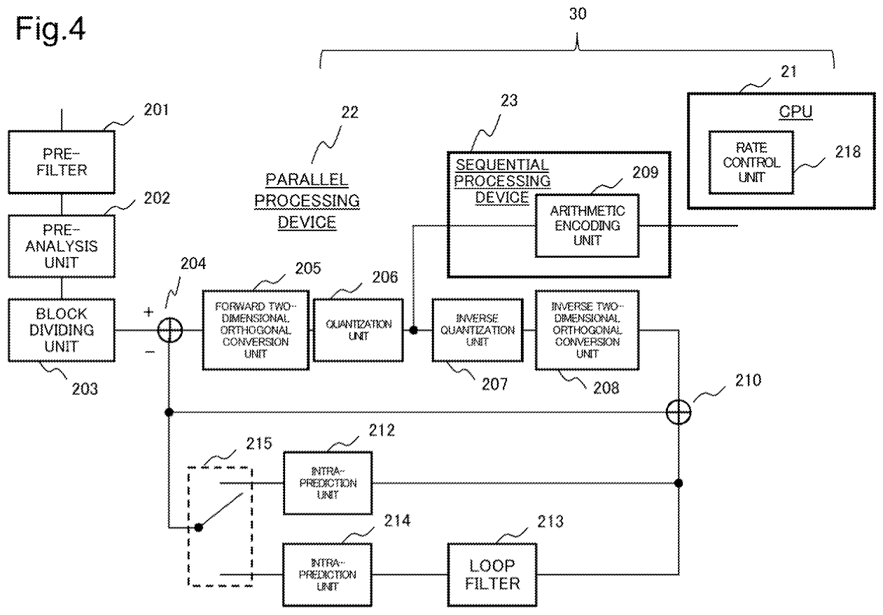

The processing performed by the forward two-dimensional orthogonal conversion unit 205, the quantization unit 206, the inverse quantization unit 207, and the inverse two-dimensional orthogonal conversion unit 208 is processing having a moderate speed-increasing effect by the parallel processing and requiring a moderate amount of processing. Therefore, the parallel processing device 22 or the sequential processing device 23 performs the processing of the forward two-dimensional orthogonal conversion unit 205, the quantization unit 206, the inverse quantization unit 207, and the inverse two-dimensional orthogonal conversion unit 208. FIG. 3 is an example of the video encoding system 20 in a case where the sequential processing device 23 performs the processing of the forward two-dimensional orthogonal conversion unit 205, the quantization unit 206, the inverse quantization unit 207, and the inverse two-dimensional orthogonal conversion unit 208. FIG. 4 is an example of a video encoding system 30 in a case where the parallel processing device 22 performs the processing of the forward two-dimensional orthogonal conversion unit 205, the quantization unit 206, the inverse quantization unit 207, and the inverse two-dimensional orthogonal conversion unit 208.

The arithmetic encoding unit 209 encodes the output of the quantization unit 206 based on the generation frequency of information “0” and “1” to be encoded. The more the generation frequency is biased, the smaller the transmission capacity of an output bit stream is. The processing performed by the arithmetic encoding unit 209 is processing having a moderate speed-increasing effect by the parallel processing, a low amount of processing, and that involves a low frequency of alteration of content of an algorithm. Therefore, the sequential processing device 23 performs the processing of the arithmetic encoding unit 209.

The addition unit 210 adds the output of the inverse two-dimensional orthogonal conversion unit 208 and the prediction image output from the switching unit 215, and outputs the result to the intra-prediction unit 212 and the loop filter 213. The processing of the addition unit 210 may be performed by any of the CPU 21, the parallel processing device 22, and the sequential processing device 23.

The intra-prediction unit 212 performs the prediction on an encoding target block in a screen by using only an encoding target picture. The processing performed by the intra-prediction unit 212 is processing having a moderate speed-increasing effect by the parallel processing and requiring a moderate amount of processing. Therefore, the parallel processing device 22 or the sequential processing device 23 performs the processing of the intra-prediction unit 212. FIG. 3 is a configuration example of the video encoding system 20 in a case where the processing of the intra-prediction unit 212 is performed by the sequential processing device 23. FIG. 4 is a configuration example of the video encoding system 20 in a case where the processing of the intra-prediction unit 212 is performed by the parallel processing device 22. The sequential processing device 23 may perform the processing of the arithmetic encoding unit 209 and the processing of the intra-prediction unit 212, and the processing of the forward two-dimensional orthogonal conversion unit 205, the quantization unit 206, the inverse quantization unit 207, and the inverse two-dimensional orthogonal conversion unit 208 may be performed by the parallel processing device 22.

The loop filter 213 is a filter applied to an image output from the switching unit 215 to bring the image closer to the input image. The processing performed by the loop filter 213 is processing having a great speed-increasing effect by the parallel processing.

Therefore, the parallel processing device 22 performs the processing of the loop filter 213.

The inter-prediction unit 214 performs inter-screen prediction on an encoding target block by also using a picture other than an encoding target with respect to the output of the loop filter 213. The processing performed by the inter-prediction unit 214 is processing having a great speed-increasing effect by the parallel processing. Therefore, the parallel processing device 22 performs the processing of the inter-prediction unit 214.

The switching unit 215 selects an appropriate image from an intra-prediction image supplied from the intra-prediction unit 212 and an inter-prediction image supplied from the inter-prediction unit 214, and outputs the selected image as a prediction image. The processing of the switching unit 215 may be performed by any of the CPU 21, the parallel processing device 22, and the sequential processing device 23.

The rate control unit 218 calculates the quantization granularity of a picture to be encoded next by using information regarding the input image obtained from the pre-analysis unit 202 and encoded information (bit number) obtained from the arithmetic encoding unit 209. The rate control unit 218 controls the transmission rate of a bit stream output from the arithmetic encoding unit 209 by calculating the quantization granularity of a picture to be encoded next. The processing of the rate control unit 218 is processing that does not require the parallel processing and has a higher frequency of alteration of an algorithm. Therefore, the CPU 21 performs the processing of the rate control unit 218.

By configuring the video encoding system 20 in this manner, in the video encoding system 20, the parallel processing device 22 capable of executing the parallel processing at a higher speed than the CPU 21 performs processing having a greater speed-increasing effect by performing the parallel processing. The sequential processing device 23 capable of executing the sequential processing at a higher speed than the CPU 21 performs the processing with a high computational load or the processing that requires high-speed processing based on the sequential processing. The CPU 21 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

Next, an operation example of the video encoding system 20 of the present example embodiment is described with reference to FIG. 2.

The parallel processing device 22 performs processing having a greater speed-increasing effect by performing the parallel processing among pieces of processing related to compression encoding of a video (Step S101). In the case of the present example embodiment, the processing performed by the parallel processing device 22 includes pre-filter processing, pre-analysis processing, loop filter processing, and inter-prediction processing. The processing performed by the parallel processing device 22 may further include processing that is not performed by the sequential processing device 23 among forward two-dimensional orthogonal conversion processing, quantization processing, inverse quantization processing, inverse two-dimensional orthogonal conversion processing, and intra-prediction processing.

The sequential processing device 23 performs processing with a high computational load or processing that requires high-speed processing based on sequential processing among pieces of processing related to compression encoding (Step S102). In the case of the present example embodiment, the processing performed by the sequential processing device 23 includes arithmetic encoding processing. The processing performed by the sequential processing device 23 may further include at least one of the forward two-dimensional orthogonal conversion processing, the quantization processing, the inverse quantization processing, the inverse two-dimensional orthogonal conversion processing, and the intra-prediction processing.

The CPU 21 performs processing that involves a high frequency of alteration of content of an algorithm among pieces of processing related to compression encoding (Step S103). In the case of the present example embodiment, the processing performed by the CPU includes rate control processing.

The video encoding system 20 operates as described above in such a way that the parallel processing device 22 capable of executing the parallel processing at a higher speed than the CPU 21 performs processing having a greater speed-increasing effect by performing the parallel processing. The sequential processing device 23 capable of executing the sequential processing at a higher speed than the CPU 21 performs the processing with a high computational load or the processing that requires high-speed processing based on the sequential processing. The CPU 21 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

As described above, in the second example embodiment of the present invention, in the video encoding system 20, the parallel processing device 22 capable of executing the parallel processing at a higher speed than the CPU 21 performs processing having a greater speed-increasing effect by performing the parallel processing. The sequential processing device 23 capable of executing the sequential processing at a higher speed than the CPU 21 performs the processing with a high computational load or the processing that requires high-speed processing based on the sequential processing. The

CPU 21 performs the processing that involves a high frequency of alteration of content of an algorithm. This makes it possible to perform the compression encoding at a higher speed than the method of using only the CPU, the method of using the two: the CPU and the FPGA, and the method of using the two: the CPU and the GPU. The compression encoding can be performed by a simpler method than the method of using a hardware encoder using a dedicated LSI. Therefore, the compression encoding of a video can be performed at a higher speed by a simpler method.

In the present example embodiment, the case where the system of compression encoding of a video is VVC is described. However, the video encoding system 20 of the present example embodiment is also applicable to a case where the compression encoding system is H.265 (high efficiency video coding (HEVC)), H.264/moving picture experts group (MPEG)-4 advanced video coding (AVC), Windows (registered trademark) media video (WMV), alliance for open media video 1 (AV1), VP9, or the like.

### [Hardware Configuration Example]

A configuration example of hardware resources for achieving the video encoding system (10, 20) according to each of the above-described example embodiments of the present invention using one information processing device (computer) is described. The video encoding system may be achieved by using a plurality of, at least two or more, information processing devices physically or functionally. The video encoding system may be achieved as a dedicated device, or a general-purpose device may be used. Only some of the functions of the video encoding system may be achieved by using the information processing device.

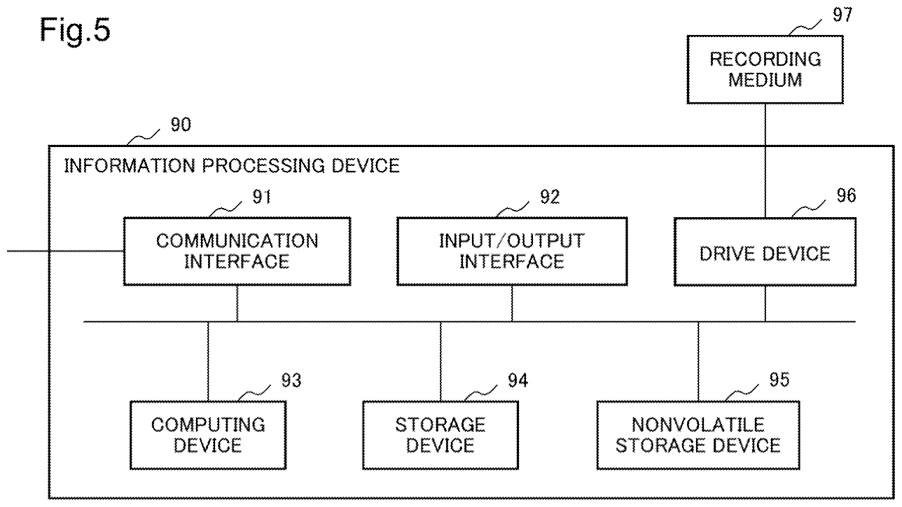

FIG. 5 is a diagram schematically illustrating a hardware configuration example of an information processing device capable of achieving the video encoding system of each of the example embodiments of the present invention. An information processing device 90 includes a communication interface 91, an input/output interface 92, a computing device 93, a storage device 94, a nonvolatile storage device 95, and a drive device 96.

For example, the CPU 11, the parallel processing device 12, and the sequential processing device 13 in FIG. 1 correspond to the computing device 93.

The communication interface 91 is a communication means for the video encoding system of each of the example embodiments to communicate with an external device in at least one of wired and wireless manners. In a case where the video encoding system is achieved by using at least two information processing devices, these devices may be communicably connected via the communication interface 91.

The input/output interface 92 is a man-machine interface such as a keyboard as an example of an input device or a display as an output device.

The computing device 93 is achieved by, for example, a computation processing device such as a central processing unit (CPU) or a microprocessor, or a plurality of electric circuits. For example, the computing device 93 can read various programs stored in the nonvolatile storage device 95 into the storage device 94 and execute processing according to the read programs.

The storage device 94 is a memory device such as random access memory (RAM) that can be referred to from the computing device 93, and stores programs, various data, and the like. The storage device 94 may be a volatile memory device.

The nonvolatile storage device 95 is, for example, a nonvolatile storage device such as read only memory (ROM), flash memory, or the like, and can store various programs, data, and the like.

The drive device 96 is, for example, a device that processes reading and writing of data recorded in a recording medium 97 described below.

The recording medium 97 is any recording medium capable of recording data, for example, an optical disk, a magneto-optical disk, semiconductor flash memory, or the like.

Each of the example embodiments of the present invention may be achieved, for example, by configuring the video encoding system by the information processing device 90 illustrated in FIG. 5 and supplying a program capable of achieving the functions described in each of the example embodiments described above to the video encoding system.

In this case, the computing device 93 executes the program supplied to the video encoding system, and the example embodiments can be achieved. Not all but some of the functions of the video encoding system can be configured by the information processing device 90.

The program described above may be recorded in the recording medium 97, and the program described above may be appropriately configured to be stored in the nonvolatile storage device 95 at a shipping stage, an operation stage, or the like of the video encoding system. In this case, the method of supplying the program described above may employ a method of installing the program in the video encoding system by using an appropriate jig in a manufacturing stage before shipment, an operation stage, or the like. As a method of supplying the program described above, a general procedure such as a method of downloading the program from the outside via a communication line such as the Internet may be adopted.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-052601, filed on Mar. 24, 2020, the disclosure of which is incorporated herein in its entirety by reference.

### REFERENCE SIGNS LIST

10, 20 video encoding system
11, 21 CPU
12, 22 parallel processing device
13, 23 sequential processing device
201 pre-filter
202 pre-analysis unit
203 block dividing unit
204 subtraction unit
205 forward two-dimensional orthogonal conversion unit
206 quantization unit
207 inverse quantization unit
208 inverse two-dimensional orthogonal conversion unit
209 arithmetic encoding unit
210 addition unit
212 intra-prediction unit
213 loop filter
214 inter-prediction unit
215 switching unit
218 rate control unit
90 information processing device
91 communication interface
92 input/output interface
93 computing device
94 storage device
95 nonvolatile storage device
96 drive device
97 recording medium

1. A video encoding system comprising:
a central processing unit (CPU);
a parallel processing device capable of executing parallel processing at a higher speed than the CPU; and
a sequential processing device capable of executing sequential processing at a higher speed than the CPU, wherein
the parallel processing device performs processing having a greater speed-increasing effect by performing the parallel processing among pieces of processing related to compression encoding of a video,
the sequential processing device performs processing with a high computational load or processing that requires high-speed processing based on the sequential processing among the pieces of processing related to the compression encoding, and
the CPU performs processing that involves a high frequency of alteration of content of an algorithm among the pieces of processing related to the compression encoding.

2. The video encoding system according to claim 1, wherein
the processing performed by the parallel processing device includes pre-filter processing, pre-analysis processing, loop filter processing, and inter-prediction processing,
the processing performed by the sequential processing device includes arithmetic encoding processing, and
the processing performed by the CPU includes rate control processing.

3. The video encoding system according to claim 2, wherein
the processing performed by the sequential processing device further includes at least one of forward two-dimensional orthogonal conversion processing, quantization processing, inverse quantization processing, inverse two-dimensional orthogonal conversion processing, and intra-prediction processing.

4. The video encoding system according to claim 3, wherein
the processing performed by the parallel processing device further includes, among the forward two-dimensional orthogonal conversion processing, the quantization processing, the inverse quantization processing, the inverse two-dimensional orthogonal conversion processing, and the intra-prediction processing, processing not performed by the sequential processing device.

5. A video encoding method comprising:
performing, among pieces of processing related to compression encoding of a video, processing having a greater speed-increasing effect by performing parallel processing by a parallel processing device capable of executing the parallel processing at a higher speed than a central processing unit (CPU);
performing processing with a high computational load or processing that requires high-speed processing based on sequential processing by a sequential processing device capable of executing the sequential processing at a higher speed than the CPU; and
performing processing that involves a high frequency of alteration of content of an algorithm by the CPU.

6. The video encoding method according to claim 5, wherein
the processing performed by the parallel processing device includes pre-filter processing, pre-analysis processing, loop filter processing, and inter-prediction processing,
the processing performed by the sequential processing device includes arithmetic encoding processing, and
the processing performed by the CPU includes rate control processing.

7. The video encoding method according to claim 6, wherein
the processing performed by the sequential processing device further includes at least one of forward two-dimensional orthogonal conversion processing, quantization processing, inverse quantization processing, inverse two-dimensional orthogonal conversion processing, and intra-prediction processing.

8. The video encoding method according to claim 7, wherein the processing performed by the parallel processing device further includes, among the forward two-dimensional orthogonal conversion processing, the quantization processing, the inverse quantization processing, the inverse two-dimensional orthogonal conversion processing, and the intra-prediction processing, processing not performed by the sequential processing device.
